(19) United States
(12) Patent Application Publication
(10) Pub. No.: US 2012/0215521 A1
(43) Pub. Date: Aug. 23, 2012

(54) Software Application Method to Translate an Incoming Message, an Outgoing Message, or an User Input Text

(76) Inventor: Mark L. SISTRUNK, Maple Heights, OH (US)

(21) Appl. No.: 13/399,948

(22) Filed: Feb. 17, 2012

Related U.S. Application Data
(60) Provisional application No. 61/444,453, filed on Feb. 18, 2011.

(51) Int. Cl. G06F 17/28

(52) U.S. Cl. 704/3

(57) ABSTRACT

The present invention is a software application that is capable of translating incoming messages, outgoing messages, and user input texts, such as E-books and online articles. The software application can be installed onto any electronic communication device, such as a cellular phone, a computer, a videophone, or a smart-television, which allows the electronic device to become a universal communicator. The software application follows a process to translate source text into target text and requires a plurality of software engines to follow that process. The plurality of software engines includes a spoken language identification engine, a written language identification engine, a machine translation engine, a text-to-speech engine, and a speech-to-text engine. The software application is able to access a contact database, which stores the information for all of the user's contacts, and a linguistic database, which stores the information that is required to translate one language to another language.

The current application claims a priority to the U.S. Provisional Patent application Ser. No. 61/444,453 filed on Feb. 18, 2011.

### FIELD OF THE INVENTION

The present invention generally relates to a software application that allows an electronic communication device, such as a cellular phone, to translate incoming and outgoing messages.

### BACKGROUND OF THE INVENTION

The present invention is a software application that is designed to allow individuals, who speak different languages, to clearly and easily communicate with each other. The present invention allows an electronic communication device, such as a cellular phone, to translate incoming and outgoing messages into a variety of languages. Users may speak or type messages with the software application and then press a “translate” button to select a language in order to send the message in that language. Upon receiving messages in a foreign language, users may again press the “translate” button, select the desired language, and view or listen to the message in the desired language.

Many individuals find themselves in situations that require knowledge of other languages. While vacationing, working, or visiting areas in which the native language is unfamiliar, individuals may find themselves unable to communicate with the people around them. This can be highly problematic, especially if these individuals become lost, are sent to the hospital, or find themselves in other emergency situations. Thus, the present invention is necessary because the software application allows the electronic communication device to become a universal communicator.

The present invention provides individuals with an effective and accurate method for communicating with persons who speak other languages. The present invention can also be designed to accommodate specific kinds of cellular phones and to suit user preferences. To use the present invention, consumers may simply type or speak a message in their cellular phone, press “translate” to select a language, and send the message to the desired recipient. The recipient can then receive the message spoken or written in the language which it was sent. Alternatively, recipients may change the language of the received message by pressing the “translate” button and selecting a language. The exact specifications of the present invention may vary.

### BRIEF DESCRIPTION OF THE DRAWINGS

FIG. 1 is a flow chart illustrating the overall process that is followed by the present invention.

FIG. 2 is a flow chart illustrating the secondary process that is followed by the machine translation engine during the overall process.

FIG. 3 is a flow chart illustrating the secondary process that allows the present invention to deal with incoming messages in an audio data format during the overall process.

FIG. 4 is a flow chart illustrating the secondary process that allows the present invention to deal with incoming messages in a textual data format during the overall process.

FIG. 5 is a flow chart illustrating the secondary process that allows the present invention to deal with subsequent incoming messages from the same contact person.

FIG. 6 is a flow chart illustrating the secondary process that allows the present invention to deal with outgoing messages in an audio data format during the overall process.

FIG. 7 is a flow chart illustrating the secondary process that allows the present invention to deal with outgoing messages in a textual data format during the overall process.

FIG. 8 is a flow chart illustrating the secondary process that allows the present invention to deal with outgoing message to the same contact person.

FIG. 9 is a flow chart illustrating the secondary process that allows the present invention to deal with user input texts, such as an E-book or online content.

### DETAIL DESCRIPTIONS OF THE INVENTION

All illustrations of the drawings are for the purpose of describing selected versions of the present invention and are not intended to limit the scope of the present invention.

The present invention is a software application that can be downloaded to an electronic communication device such as a smart-phone. The electronic communication device should have a physical keyboard or a virtual keyboard, a flat screen, a speaker, and a microphone, which are components found on a traditional smart-phone. The electronic communication device can also be a smart-television, a desktop computer, a laptop computer, a tablet personal computer, or a videophone. Once the present invention is installed on the electronic communication device, the present invention allows a user to translate an incoming message, an outgoing message, or a user input text from one language to another language with the electronic communication device. The present invention is able to translate the incoming message whether the user is receiving a text message or receiving the incoming audio portion of a phone call conversation. Similarly, the present invention is able to translate the outgoing message whether the user is sending a text message or sending the outgoing portion of a phone call conversation. The user input text is any kind of electronic text such as an E-book or online content. In addition, the source text is the content of either the incoming message, the outgoing message, or the user input text in its original language. The target text is the content of the incoming message, the outgoing message, or the user input text in its preferred language. As mentioned above, the software application can be run in a plurality of communication formats, which includes a phone call conversation or a text message conversation.

The software application uses the computing features of the electronic communication device to follow a computer-executable process that translates the source text into the target text. In order for the software application to follow the computer-executable process, the present invention requires a plurality of software engines, which includes a spoken language identification engine, a written language identification engine, a machine translation engine, a text-to-speech engine, and a speech-to-text engine. The spoken language identification engine allows the software application to determine the original language of the source text if the source text is the audio portion of a phone call conversation. The written language identification engine allows the software application to determine the original language of the source text if the source text is a text message. The machine translation engine is used by the software application to convert the source text into the target text. The machine translation engine does a word-by-word substitution between the source text and the target text and uses statistically and corpus methods to improve the word-by-word substitution, to improve the translation of idioms, and to isolate anomalies within the word-by-word substitution. The text-to-speech engine is used to convert textual content into audio content, and the speech-to-text engine is used to convert the audio content into textual content. The plurality of software engines can be programmed by software developers so that present invention can follow the computer-executable process.

Also, in order for the software application to follow the computer-executable process, the present invention requires a contact database and a linguistic database. The contact database contains an information profile for each of the user's contacts. The information profile comprises a default language and contact information, such as a telephone number or an email, for each person in the contact database. The default language is the natural language for a person in the contact database. The linguistic database contains a plurality of language conversion templates, which outline the proper substitutions that need to be made in order to convert one language to another language. The present invention can only translate between two languages if the linguistic database has a language conversion template for them.

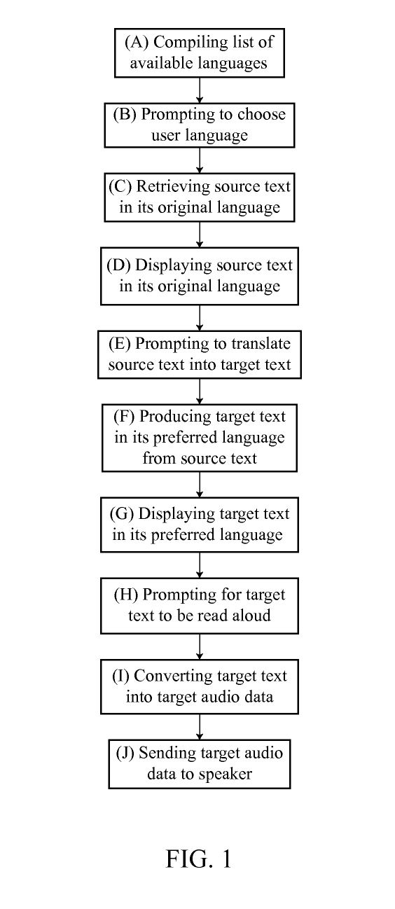

As can be seen in FIG. 1, the overall process of the present invention delineates the primary steps that need to taken in order to translate an incoming message, an outgoing message, or a user input text from one language to another language. The overall process begins by compiling a list of available languages from the plurality of language conversion templates because the language conversion template for a particular language has to be available in the linguistic database in order to make that particular language available to user. The present invention then prompts the user to choose a user language by displaying the list of available languages on a graphic user interface. The user language is the language the user is best able to naturally speak and write in. The graphic user interface is a screen that allows the user to interact with the present invention. The overall process continues by retrieving a source text in its original language. As mentioned above, the source text can come from an incoming message, an outgoing message, or a user input data. The source text is then displayed to user on the graphic user interface so that the user can view the source text in its original language. While displaying the source text in its original language, the present invention will prompt the user to translate the source text into the target text by displaying a translate button on the graphic user interface. If the user presses the translate button, then the present invention will produce the target text from source text by using the machine translation engine. Once the target text is produced by the machine translation engine, the present invention displays the target text in the preferred language to the user through the graphic user interface so that the user can see the translation of the source text. While displaying the target text in the preferred language, the present invention will prompt the user to have the target text spoken aloud with the electronic communication device by display a speak button on the graphic user interface. If the user agrees to have the target text spoken aloud, then the present invention will convert the target text into target audio data by using the text-to-speech engine. The target audio data can be used by the speaker to have the target text spoken aloud in the preferred language to the user, and, thus, the present invention sends to target audio data to the speaker.

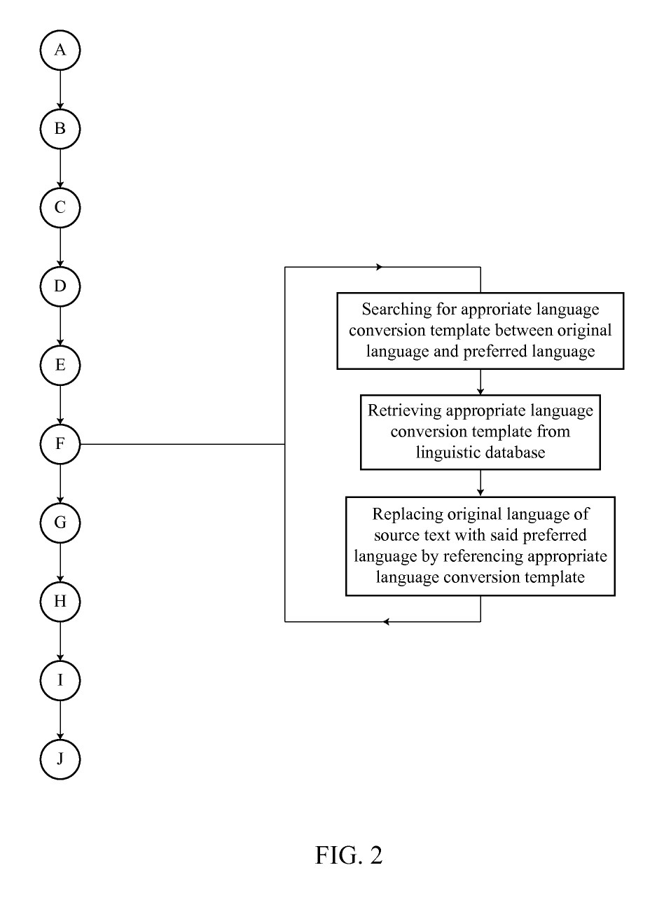

Within the overall process of the present invention, the machine translation engine follows a process to translate the source text into the target text, which is shown in FIG. 2. This process begins by searching through each of the plurality of language conversion templates to find an appropriate language conversion template for the original language and the preferred language. The appropriate language conversion template has all of the necessary substitutions between the original language and the preferred language. The machine translation engine will then retrieve the appropriate language conversion template from the linguistic database. The machine translation engine continues this process by replacing the original language of the source text with the preferred language in order to produce the target text. The appropriate language conversion template was retrieved by the machine translation engine so that the machine translation engine could refer to the appropriate language conversion template while replacing the original language of the source text with the preferred language.

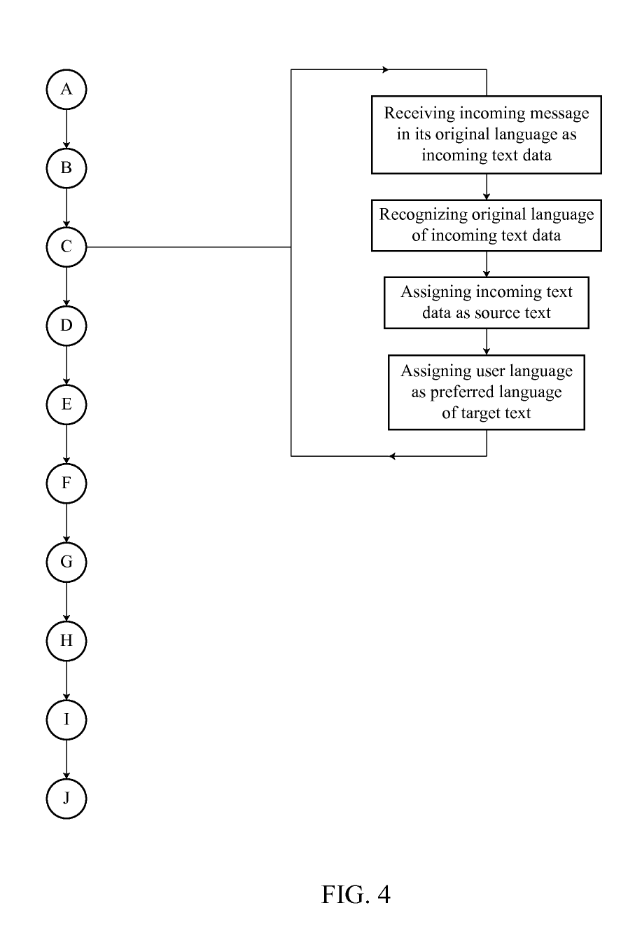

The present invention also follows a number of secondary processes, which depends on whether the source text comes from an incoming message, an outgoing message, or a user input text. One secondary process allows the present invention to deal with an incoming message that is a text message and is illustrated in FIG. 4. This process occurs before the source text is translated into the target text for the overall process. This process begins by receiving the incoming message in its original language as incoming text data through the electronic communication device. The incoming text data is the content of the incoming message in a textual data format, which can be interpreted by the software application. The present invention will then recognize the original language of the incoming text data by using the written language identification engine. Once the original language is determined by the written language identification engine, this process continues by assigning the incoming text data to be the source text for the overall process of the present invention. Finally, the present invention will recognize the user language to be the preferred language of the target text for the overall process of the present invention.

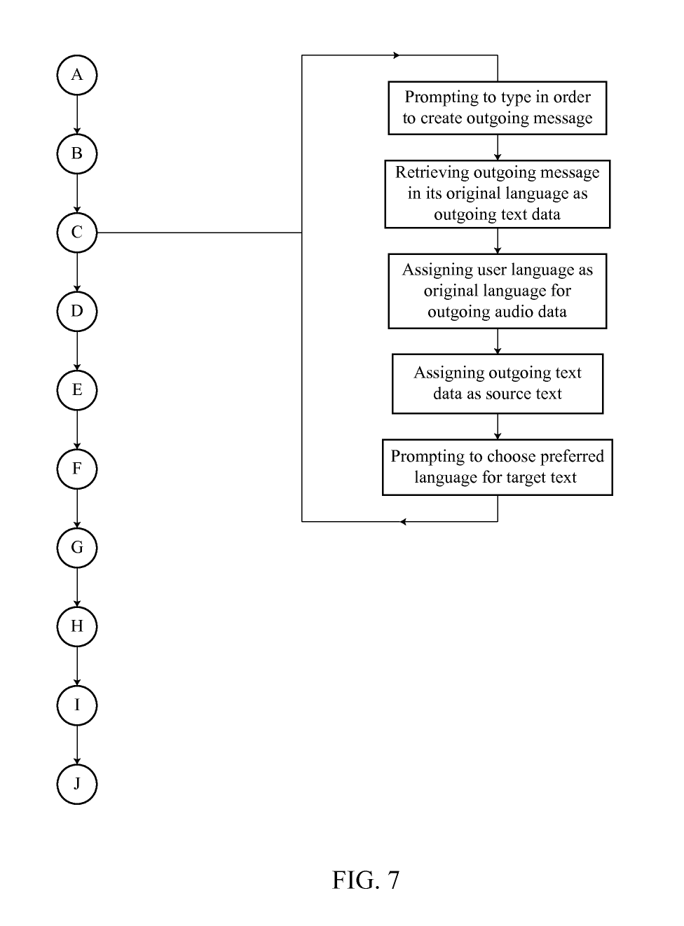

As can be seen in FIG. 7, another secondary process allows the user to create an outgoing message by typing with a physical keyboard on the electronic communication device or with a virtual keyboard on the graphic user interface. This process occurs before the source text is translated into the target text for the overall process. This process begins by prompting the user to type the outgoing message on the physical keyboard or the virtual keyboard. If the user agrees type the outgoing message, then the present invention retrieves the outgoing message in its original language as outgoing text data. The outgoing text data is the content of the outgoing message in a textual data format, which can be interpreted by the software application. This process continues by assigning the user language as the original language of the outgoing text data so that the software application does not have to identify the original language of the outgoing message. The present invention will then assign the outgoing text data as the source text for the overall process of the present invention. The process will conclude by prompting the user to choose the preferred language for the target text in the overall process. The user chooses the preferred language from the list of available languages, which is displayed on the graphic user interface.

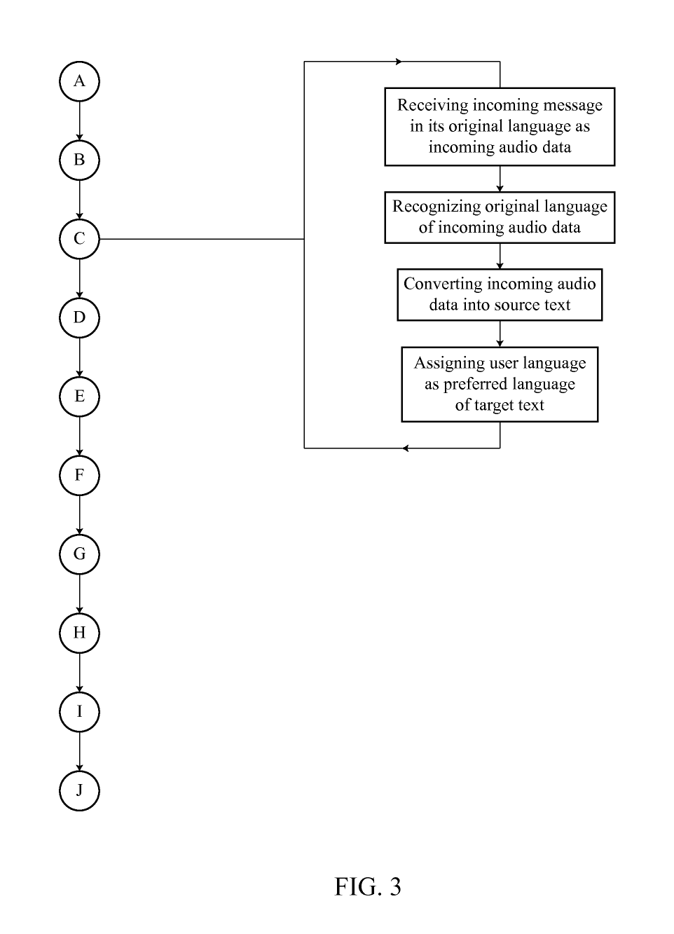

Another secondary process allows the user to receive an incoming message as part of a phone call conversation and occurs before the source text is translated into the target text for the overall process. This process is illustrated in FIG. 3. This process begins by receiving the incoming message in its original language as incoming audio data through the electronic communication device. The incoming audio data is the content of the incoming message in an audio data format, which can be interpreted by the software application. The present invention recognizes the original language of the incoming audio data by using the spoken language identification engine. The present invention then uses the speech-to-text engine to convert the incoming audio data into the source text. Once the source text has been created by the speech-to-text engine, the process concludes by assigning the user language as the preferred language of the target text in the overall process of the present invention.

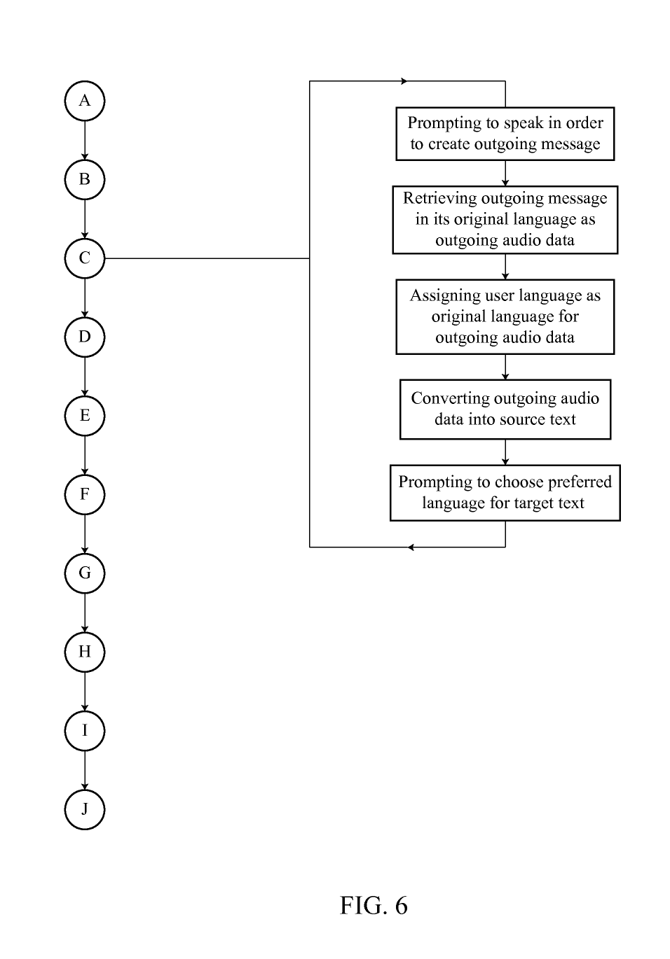

Another secondary process allows the user to create an outgoing message as part of a phone call conversation and occurs before the source text is translated into the target text for the overall process. This same process can be used to create a text message without the physical keyboard or the virtual keyboard. This process is shown in FIG. 6 and begins by prompting the user to speak into the microphone of the electronic communication device in order to create the outgoing message, which is done by displaying a record button on the graphic user interface. Once the user creates the outgoing message, the present invention retrieves the outgoing message in its original language as outgoing audio data through the electronic communication device. The outgoing audio data is the content of the outgoing message in an audio data format, which can be interpreted by the software application. The present invention will then assign the user language as the original language for the outgoing text data so that the software application does not have to identify the original language of the outgoing message. This process continues by converting the outgoing audio data into the source text for the overall process by using the speech-to-text engine. Finally, the present invention prompts the user to choose the preferred language of the target text in the overall process. The present invention displays the list of available languages on said graphic user interface, which allows the user to choose the preferred language of the target text.

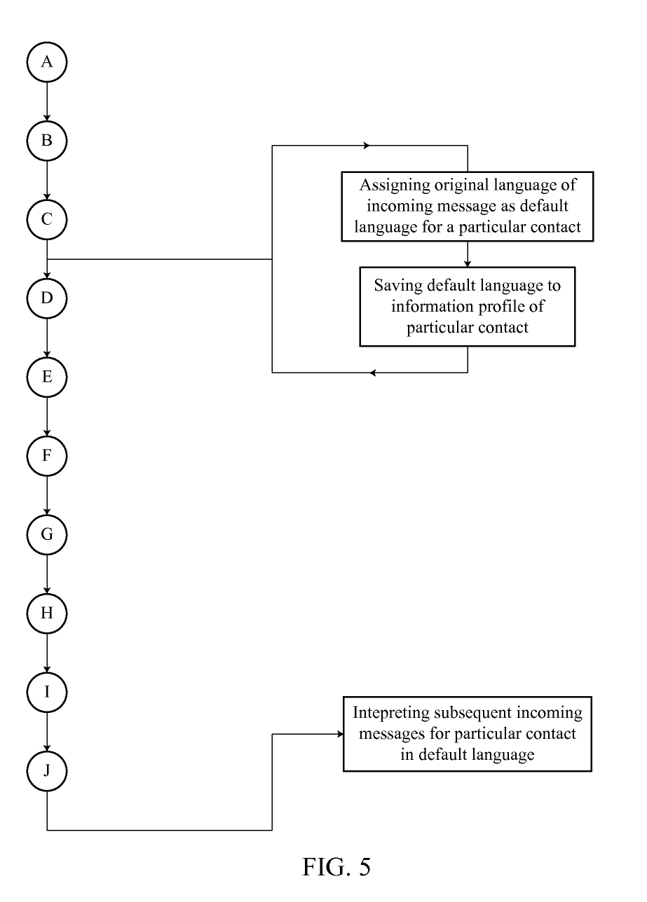

Another secondary process allows the present invention to deal with subsequent incoming messages from the same contact person without having to continuously recognize the original language with either the written language conversion engine or the spoken language conversion engine. As can be seen in the FIG. 5, this process occurs after the written language conversion engine of the spoken language conversion engine has already recognized the original language of the incoming message. This process begins by assigning the original language of said incoming message as the default language for a particular contact within the plurality of contacts. The present invention will then save the default language to the information profile of that particular contact within the contact database. Once the default language for that particular contact is saved to the contact database, the present invention can retrieve the default language from the contact database in order to interpret any subsequent incoming messages from that particular contact person.

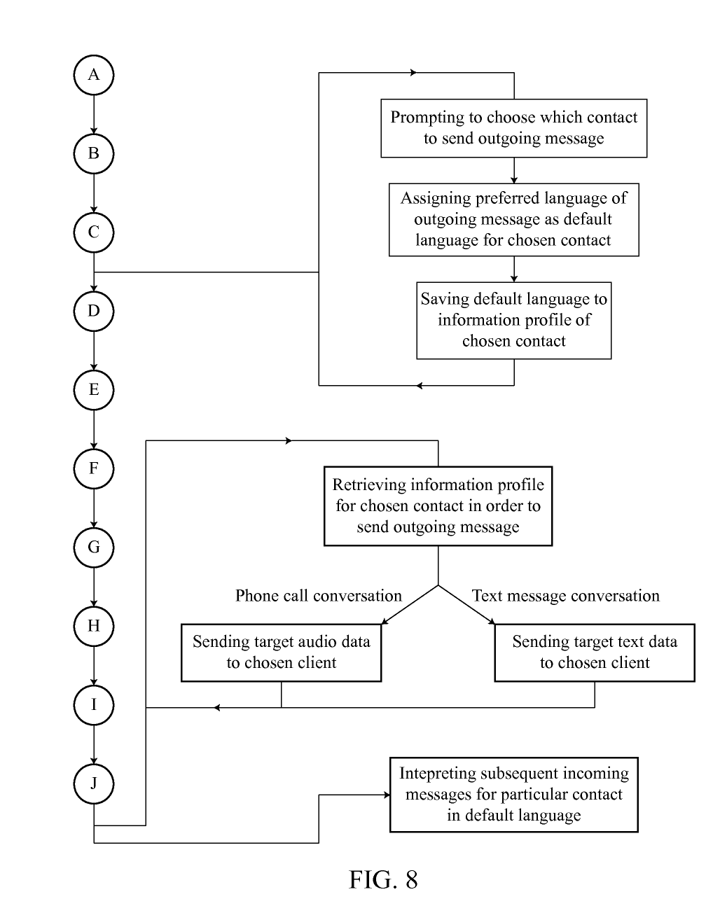

Another secondary process allows the present invention to specifically send an outgoing message to the proper contact person within the plurality of contacts. This process is shown in FIG. 8. This process occurs after the source text is translated into the target text for the overall process. This process begins by prompting the user to choose the proper contact person from the plurality of contacts, who will be sent the outgoing message. Once the proper contact person is chosen by the user, the present invention will assign the preferred language of the outgoing message as the default language for that chosen contact person. The present invention will then save the default language to the information profile within the contact database, which will prevent the need for the present invention to ask the user what is the preferred language for subsequent outgoing messages being sent to the chosen contact person. Thus, the present invention will translate subsequent outgoing messages to that chosen contact person in their default language.

Another secondary process allows the present invention to determine whether the target text of an outgoing message should be sent in a textual data format or in an audio data format to the chosen contact person. This process is also shown in FIG. 8. This process occurs at the end of the overall process and occurs after the default language for the chosen contact person is saved to their information profile. This process begins by retrieving the information profile of the chosen contact person from the contact database so that the present invention has the correct contact information to send the outgoing message. This process can then follow one of two different paths, which depends on the communication format of outgoing message. If the outgoing message is a part of a phone call conversation, then the target audio data is sent by the present invention to the chosen contact person. If the outgoing message is a part of a text message conversation, then the target text is sent by the present invention to the chosen contact person.

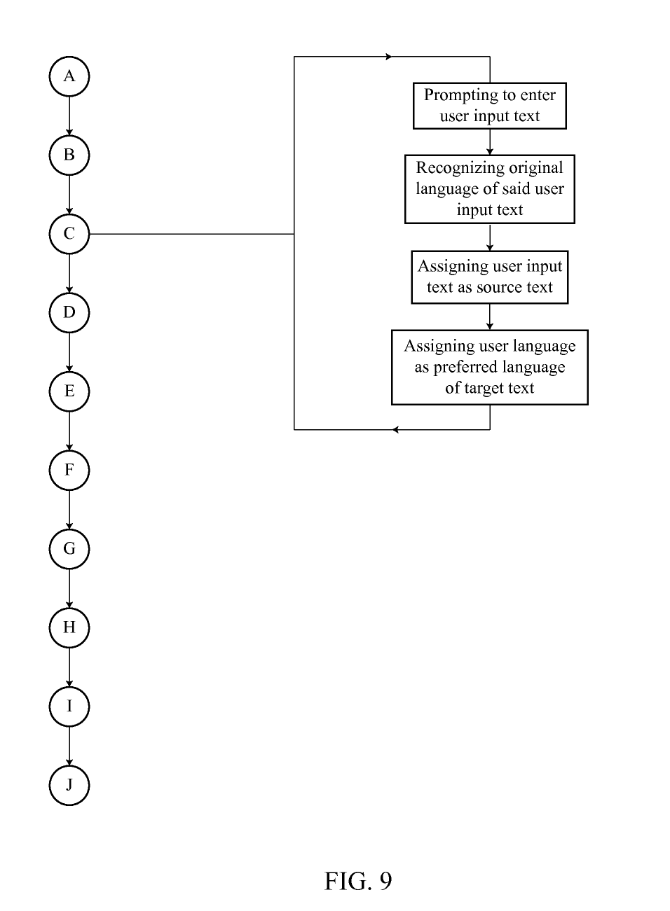

As can be seen in FIG. 9, another secondary process allows the present invention to deal with user input text, such as an E-book or an online article. This process occurs before the source text is translated into the target text for the overall process. This process begins by prompting the user to enter the user input text into the present invention, which allows the present invention to retrieve and access the user input text. The present invention will then recognize the original language of the user input text by using the written language identification engine. This process continues by assigning the user input text as the source text for the overall process. Finally, the present invention prompts the user to choose the preferred language of the target text in the overall process. The present invention displays the list of available languages on said graphic user interface, which allows the user to choose the preferred language of the target text.

Although the invention has been explained in relation to its preferred embodiment, it is to be understood that many other possible modifications and variations can be made without departing from the spirit and scope of the invention as hereinafter claimed.

What is claimed is:

1. A method of translating incoming messages, outgoing messages, and user input texts on an electronic communication device by executing computer-executable instructions stored on a non-transitory computer-readable medium, the method comprises the steps of:
providing a plurality of software engines, wherein said plurality of software engines includes a spoken language identification engine, a written language identification engine, a machine translation engine, a text-to-speech engine, and a speech-to-text engine;
providing a contact database with a plurality of contacts, wherein each of said plurality of contacts has an information profile with a default language;
providing a linguistic database with a plurality of language conversion templates;
providing a plurality of communication formats, wherein said plurality of communication formats includes a phone call conversation and a text message conversation;
compiling a list of available languages from said plurality of language conversion templates;
prompting to choose a user language by displaying said list of available languages on a graphic user interface;
retrieving a source text in an original language from either an incoming message, an outgoing message, or a user input text;
displaying said source text in said original language through said graphic user interface;
prompting to translate said source text into a target text by displaying a translate button on said graphic user interface;
producing said target text in a preferred language from said source text with said machine translation engine;
displaying said target text in said preferred language through said graphic user interface;
prompting for said target text to be read aloud by displaying a speak button on said graphic user interface;
converting said target text into target audio data with said text-to-speech engine; and
sending said target audio data to a speaker in order for said target text to be read aloud in said preferred language.

2. The method of translating incoming messages, outgoing messages, and user input texts on an electronic communication device by executing computer-executable instructions stored on a non-transitory computer-readable medium, the method as claimed in claim 1 comprises the steps of:
searching through each of said plurality of language conversion templates to find an appropriate language conversion template for said original language and said preferred language;
retrieving said appropriate language conversion template from said linguistic database; and
replacing said original language of said source text with said preferred language by referencing said appropriate language conversion template in order to produce said target text.

3. The method of translating incoming messages, outgoing messages, and user input texts on an electronic communication device by executing computer-executable instructions stored on a non-transitory computer-readable medium, the method as claimed in claim 1 comprises the steps of:
receiving said incoming message in said original language as incoming audio data;
recognizing said original language of said incoming audio data with said spoken language identification engine;
converting said incoming audio data into said source text with said speech-to-text engine; and
assigning said user language to be said preferred language of said target text.

4. The method of translating incoming messages, outgoing messages, and user input texts on an electronic communication device by executing computer-executable instructions stored on a non-transitory computer-readable medium, the method as claimed in claim 1 comprises the steps of:
receiving said incoming message in said original language as incoming text data;
recognizing said original language of said incoming text data with said written language identification engine;
assigning said incoming text data to be said source text; and
assigning said user language to be said preferred language of said target text.

5. The method of translating incoming messages, outgoing messages, and user input texts on an electronic communication device by executing computer-executable instructions stored on a non-transitory computer-readable medium, the method as claimed in claim 1 comprises the steps of:
assigning said original language of said incoming message as said default language for a particular contact within said plurality of contacts; and
saving said default language to said information profile for said particular contact within said contact database.

6. The method of translating incoming messages, outgoing messages, and user input texts on an electronic communication device by executing computer-executable instructions stored on a non-transitory computer-readable medium, the method as claimed in claim 5 comprises the steps of:
interpreting subsequent incoming messages in said default language.

7. The method of translating incoming messages, outgoing messages, and user input texts on an electronic communication device by executing computer-executable instructions stored on a non-transitory computer-readable medium, the method as claimed in claim 1 comprises the steps of:
prompting to speak in order to create said outgoing message by displaying a record button on said graphic user interface;
retrieving said outgoing message in said original language as outgoing audio data;
assigning said user language to be said original language for said outgoing audio data;
converting said outgoing audio data into said source text with said speech-to-text engine; and
prompting to choose said preferred language of said target text by displaying said list of available languages on said graphic user interface.

8. The method of translating incoming messages, outgoing messages, and user input texts on an electronic communication device by executing computer-executable instructions stored on a non-transitory computer-readable medium, the method as claimed in claim 1 comprises the steps of:
prompting to type said outgoing message through a physical keyboard or a virtual keyboard on said graphic user interface;
retrieving outgoing message in said original language as outgoing text data;
assigning said user language to be said original language of said outgoing text data;
assigning said outgoing text data to be said source text; and
prompting to choose said preferred language for said target text by displaying said list of available languages on said graphic user interface.

9. The method of translating incoming messages, outgoing messages, and user input texts on an electronic communication device by executing computer-executable instructions stored on a non-transitory computer-readable medium, the method as claimed in claim 1 comprises the steps of:
prompting to choose from said plurality of contacts in order to send said outgoing message;
assigning said preferred language of said outgoing message to be said default language; and
saving said default language to said information profile within said contact database.

10. The method of translating incoming messages, outgoing messages, and user input texts on an electronic communication device by executing computer-executable instructions stored on a non-transitory computer-readable medium, the method as claimed in claim 9 comprises the steps of:
retrieving said information profile of chosen contact from said contact database in order to send said outgoing message; and
sending said target audio data of said outgoing message to said chosen contact,
if said outgoing message is within said phone call conversation.

11. The method of translating incoming messages, outgoing messages, and user input texts on an electronic communication device by executing computer-executable instructions stored on a non-transitory computer-readable medium, the method as claimed in claim 9 comprises the steps of:
retrieving said information profile of chosen contact from said contact database in order to send said outgoing message; and
sending said target text of said outgoing message to said chosen contact,
if said outgoing message is within said text message conversation.

12. The method of translating incoming messages, outgoing messages, and user input texts on an electronic communication device by executing computer-executable instructions stored on a non-transitory computer-readable medium, the method as claimed in claim 9 comprises the steps of:
translating subsequent outgoing messages to said chosen contact in said default language.

13. The method of translating incoming messages, outgoing messages, and user input texts on an electronic communication device by executing computer-executable instructions stored on a non-transitory computer-readable medium, the method as claimed in claim 1 comprises the steps of:
prompting to enter said user input text in order to retrieve said user input text;
recognizing said original language of said user input text with said written language identification engine;
assigning said user input text to be said source text; and
assigning said user language to be said preferred language of said target text.
